(19) United States
(12) Patent Application Publication
(10) Pub. No.: US 2008/0245810 A1
(43) Pub. Date: Oct. 9, 2008

(54) METHODS AND APPARATUS FOR DISPENSING SOLID PHARMACEUTICAL ARTICLES

(75) Inventors: Edward Joseph Karwacki, Jr., Garner, NC (US); Richard D. Michelli, Raleigh, NC (US); Jennifer Ann Mauger, Durham, NC (US)

Correspondence Address: MYERS BIGEL SIBLEY & SAJOVEC, PO BOX 37428, RALEIGH, NC, 27627, US

(73) Assignee: PARATA Systems, LLC

(21) Appl. No.: 11/697,137

(22) Filed: Apr. 5, 2007

(51) Int. Cl. B65G 65/30

(52) U.S. Cl. 221/13; 221/254; 221/278

(57) ABSTRACT

An apparatus for dispensing solid pharmaceutical articles includes a housing, a flow generator and a sensor. The housing defines a dispensing passage. The flow generator is operable to generate a first flow of gas to force the articles along a first path through the dispensing passage. The sensor is positioned to detect articles passing through the dispensing passage. A port is defined in the housing adjacent the sensor and configured to direct a second flow of gas along a second path to agitate dust adjacent the sensor and thereby remove dust from the sensor and/or prevent dust from depositing on the sensor.

### FIELD OF THE INVENTION

The present invention is directed generally to the dispensing of solid pharmaceutical articles and, more specifically, is directed to the automated dispensing of solid pharmaceutical articles.

### BACKGROUND OF THE INVENTION

Pharmacy generally began with the compounding of medicines which entailed the actual mixing and preparing of medications. Heretofore, pharmacy has been, to a great extent, a profession of dispensing, that is, the pouring, counting, and labeling of a prescription, and subsequently transferring the dispensed medication to the patient. Because of the repetitiveness of many of the pharmacist's tasks, automation of these tasks has been desirable.

Some attempts have been made to automate the pharmacy environment. Different exemplary approaches are shown in U.S. Pat. No. 5,337,919 to Spaulding et al. and U.S. Pat. Nos. 6,006,946; 6,036,812 and 6,176,392 to Williams et al. These systems utilize robotic arms to grasp a container, carry it to one of a number of bins containing tablets (from which a designated number of tablets are dispensed), carry it to a printer, where a prescription label is applied, and release the filled container in a desired location. Tablets are counted and dispensed with any number of counting devices. Drawbacks to these systems typically include the relatively low speed at which prescriptions are filled and the absence in these systems of securing a closure (i.e., a lid) on the container after it is filled.

One automated system for dispensing pharmaceuticals is described in some detail in U.S. Pat. No. 6,971,541 to Williams et al. This system has the capacity to select an appropriate vial, label the vial, fill the vial with a desired quantity of a selected pharmaceutical tablet, apply a cap to the filled vial, and convey the labeled, filled, capped vial to an offloading station for retrieval. Although this particular system can provide automated pharmaceutical dispensing, it may be desirable to modify certain aspects of the system to address particular needs.

### SUMMARY OF THE INVENTION

According to embodiments of the present invention, an apparatus for dispensing solid pharmaceutical articles includes a housing, a flow generator and a sensor. The housing defines a dispensing passage. The flow generator is operable to generate a first flow of gas to force the articles along a first path through the dispensing passage. The sensor is positioned to detect articles passing through the dispensing passage. A port is defined in the housing adjacent the sensor and configured to direct a second flow of gas along a second path to agitate dust adjacent the sensor and thereby remove dust from the sensor and/or prevent dust from depositing on the sensor.

According to method embodiments of the present invention, a method is provided for dispensing solid pharmaceutical articles using an apparatus including a housing defining a dispensing passage, a flow generator, and a sensor positioned to detect articles passing through the dispensing passage. The method includes: generating a first flow of gas using the flow generator to force the articles along a first path through the dispensing passage; detecting articles passing through the dispensing passage using the sensor; and directing a second flow of gas along a second path through a port defined in the housing adjacent the sensor to agitate dust adjacent the sensor and thereby remove dust from the sensor and/or prevent dust from depositing on the sensor.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a flow chart illustrating methods according to embodiments of the present invention.

FIG. 2 is a perspective view of a pharmaceutical tablet dispensing system including a sensor clearing system according to embodiments of the present invention.

FIG. 3 is a cutaway view of the tablet dispensing system of FIG. 2 illustrating a container dispensing station, a labeling carrier, a dispensing carrier, and a closure dispensing station thereof.

FIG. 4 is a front perspective view of a dispensing bin according to embodiments of the present invention.

FIG. 5 is a cross-sectional view of the bin of FIG. 4.

FIG. 6 is a cross-sectional view of the bin of FIG. 4 wherein tablets contained therein are being agitated and dispensed.

FIG. 7 is a cross-sectional view of the bin of FIG. 4 wherein a tablet is being returned to a hopper of the bin.

FIG. 8 is a fragmentary, enlarged, front perspective view of a nozzle of the bin of FIG. 4.

FIG. 9 is a fragmentary, enlarged, right perspective view of a section of the nozzle of FIG. 8.

FIG. 10 is an enlarged, front perspective view of a left outrigger of the bin of FIG. 4.

FIG. 11 is an enlarged, rear perspective view of the left outrigger of FIG. 10.

FIG. 12 is a left side elevational view of the left outrigger of FIG. 10.

FIG. 13 is a right side elevational view of the left outrigger of FIG. 10.

FIG. 14 is a fragmentary, enlarged, top cross-sectional view of the nozzle of the bin of FIG. 4.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

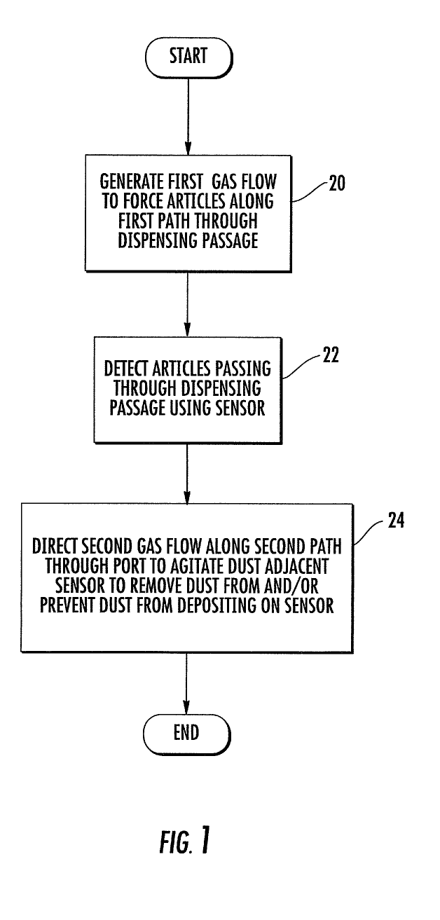

In accordance with embodiments of the present invention, apparatus and methods are provided for dispensing solid pharmaceutical articles. In particular, such methods and apparatus may be used to dispense pharmaceuticals. With reference to FIG. 1, methods according to embodiments of the present invention may be executed using an apparatus including a housing defining a dispensing passage, a flow generator, and a sensor positioned to detect articles passing through the dispensing passage. A first flow of gas (e.g., air) is generated using the flow generator to force the articles along a first path through the dispensing passage (Block 20). Articles are detected passing through the dispensing passage using the sensor (Block 22). A second flow of gas (e.g., air) is directed along a second path through a port defined in the housing adjacent the sensor to agitate dust adjacent the sensor and thereby remove dust from the sensor and/or prevent dust from depositing on the sensor (Block 24).

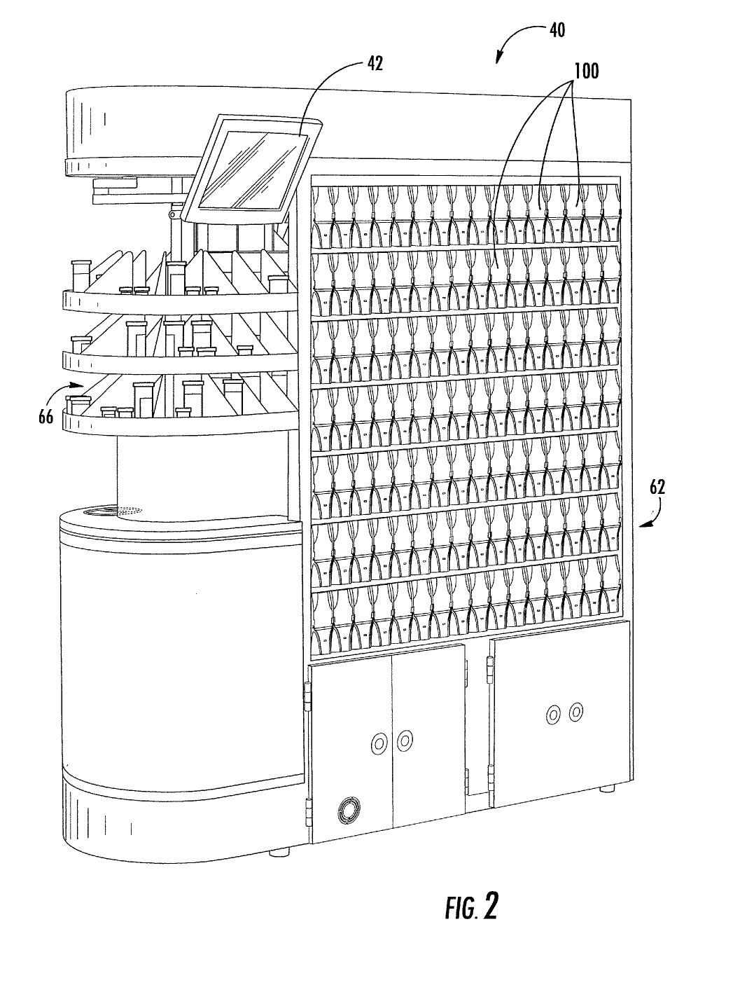

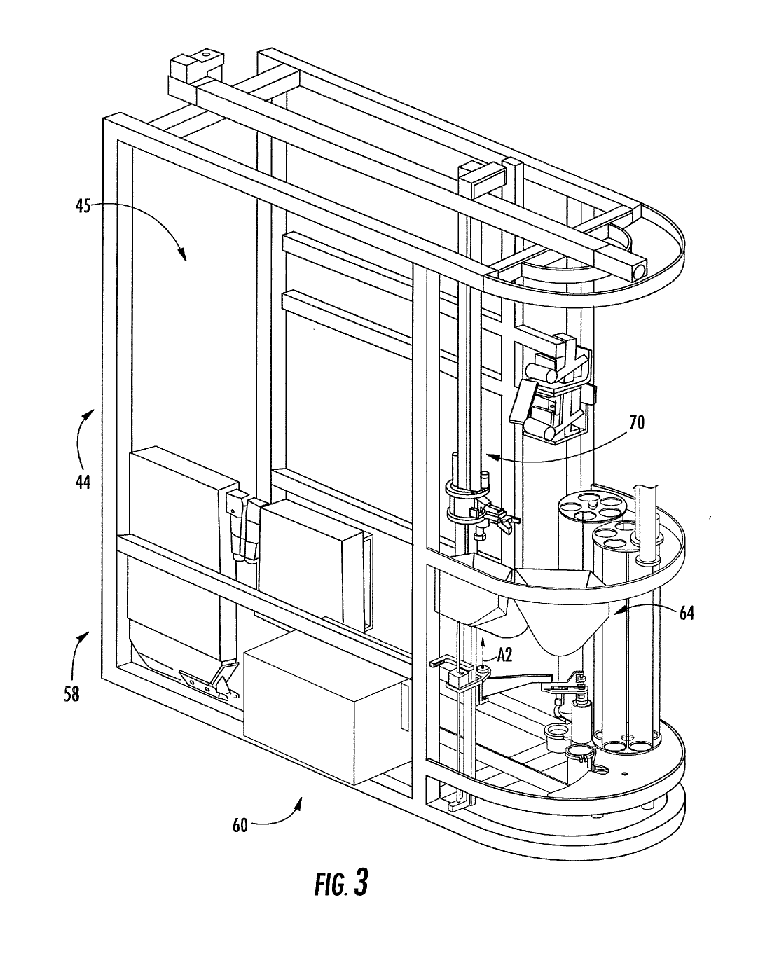

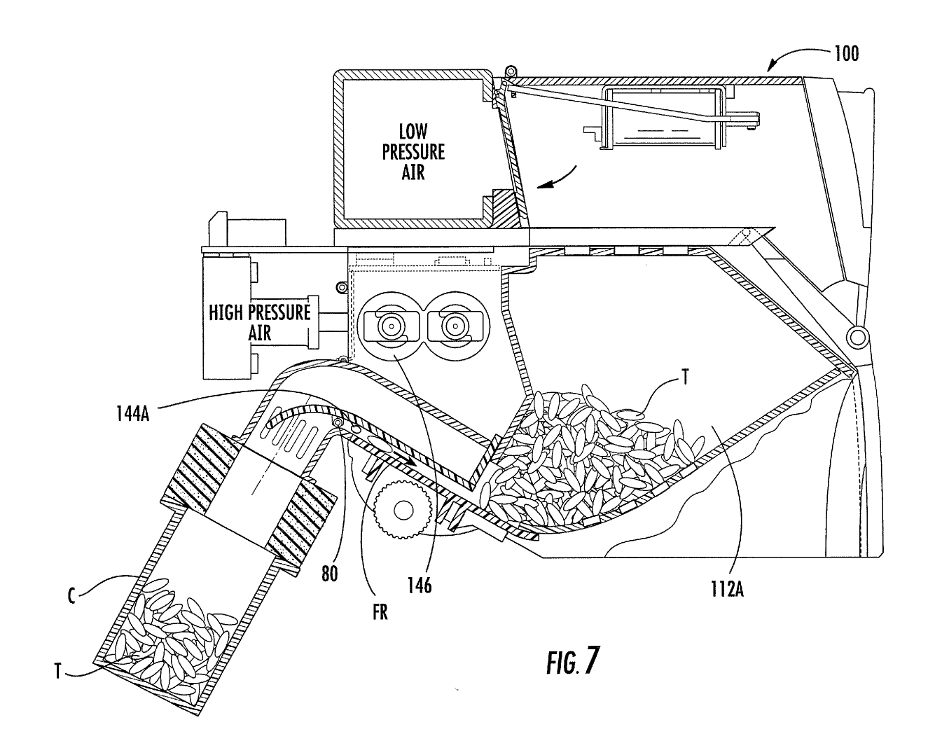

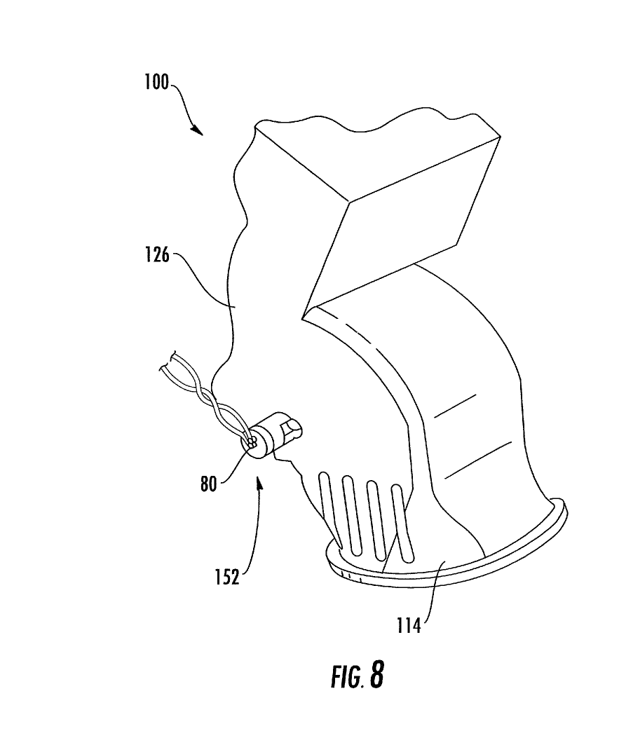

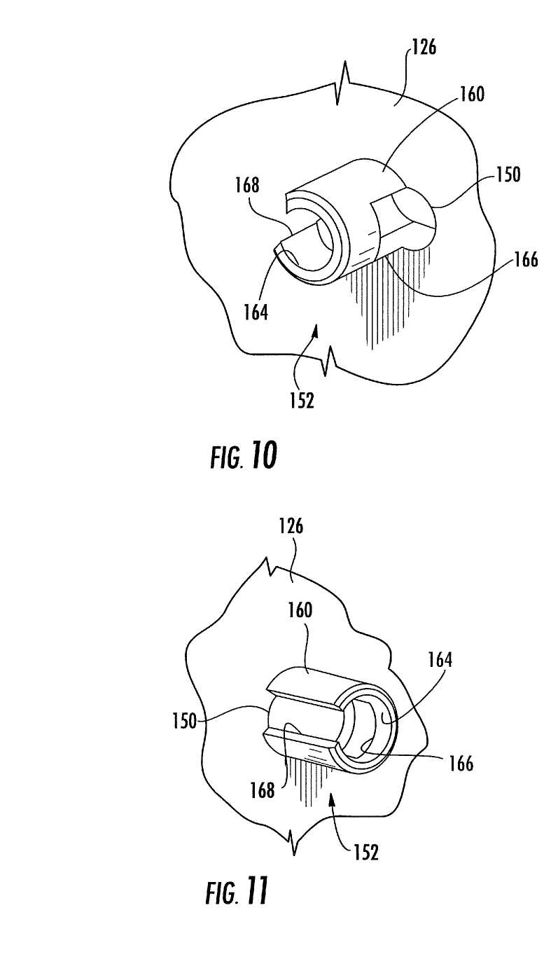

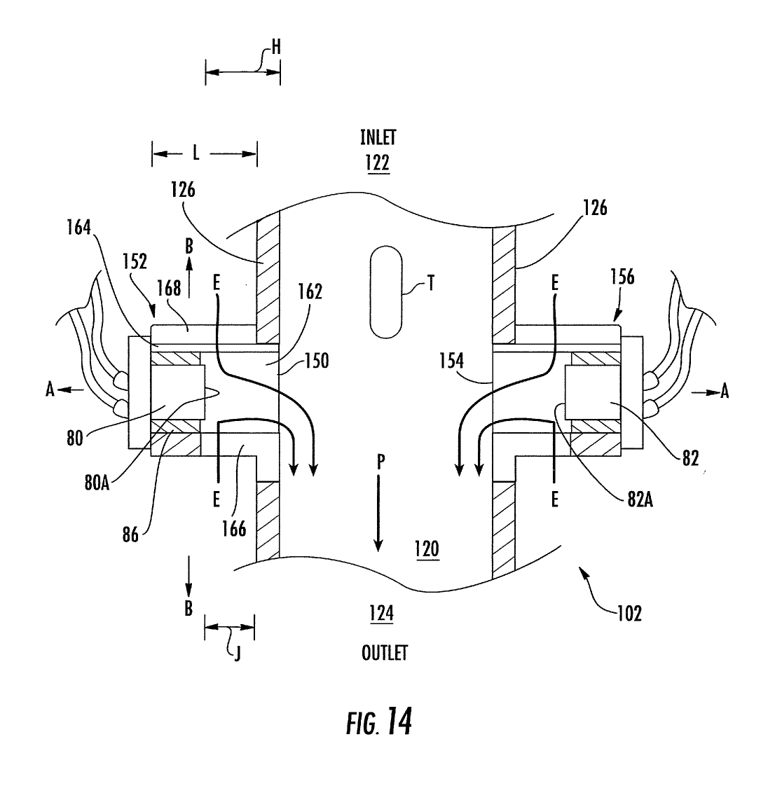

A dispensing system according to embodiments of the present invention and that can carry out the foregoing methods is illustrated in FIGS. 2-14 and designated broadly therein at 40 (FIGS. 2 and 3). The dispensing system 40 includes one or more sensor clearing systems 102 according to embodiments of the present invention. The system 40 includes a support frame 44 for the mounting of its various components. Those skilled in this art will recognize that the frame 44 illustrated herein is exemplary and can take many configurations that would be suitable for use with the present invention. The frame 44 provides a strong, rigid foundation to which other components can be attached at desired locations, and other frame forms able to serve this purpose may also be acceptable for use with this invention.

The system 40 generally includes as operative stations a controller (represented herein by a graphics user interface 42), a container dispensing station 58, a labeling station 60, a tablet dispensing station 62, a closure dispensing station 64, and an offloading station 66. In the illustrated embodiment, containers, tablets and closures are moved between these stations with a dispensing carrier 70; however, in some embodiments, multiple carriers are employed. The dispensing carrier 70 has the capability of moving the container to designated locations within the cavity 45 of the frame 44. Except as discussed herein with regard to the dispensing station 62, each of the operative stations and the conveying devices may be of any suitable construction such as those described in detail in U.S. Pat. No. 6,971,541 to Williams et al. and/or U.S. Patent Publication No. US-2006-0241807-A1, the disclosures of which are hereby incorporated herein in their entireties.

The controller 42 controls the operation of the remainder of the system 40. In some embodiments, the controller 42 will be operatively connected with an external device, such as a personal or mainframe computer, that provides input information regarding prescriptions. In other embodiments, the controller 42 may include a stand-alone computer that directly receives manual input from a pharmacist or other operator. An exemplary controller may include a conventional microprocessor-based personal computer. The controller 42 may be a centralized computer or portions thereof may be physically and/or functionally distributed or divided into multiple controllers. For example, according to some embodiments, the controller is embodied in part in each tablet dispensing bin assembly.

In operation, the controller 42 signals the container dispensing station 58 that a container of a specified size is desired. In response, the container dispensing station 58 delivers a container for retrieval by the carrier 70. From the container dispensing station 58, the container is moved to the labeling station 60 by the carrier 70. The labeling station 60 includes a printer that is controlled by the controller 42. The printer prints and presents an adhesive label that is affixed to the container.

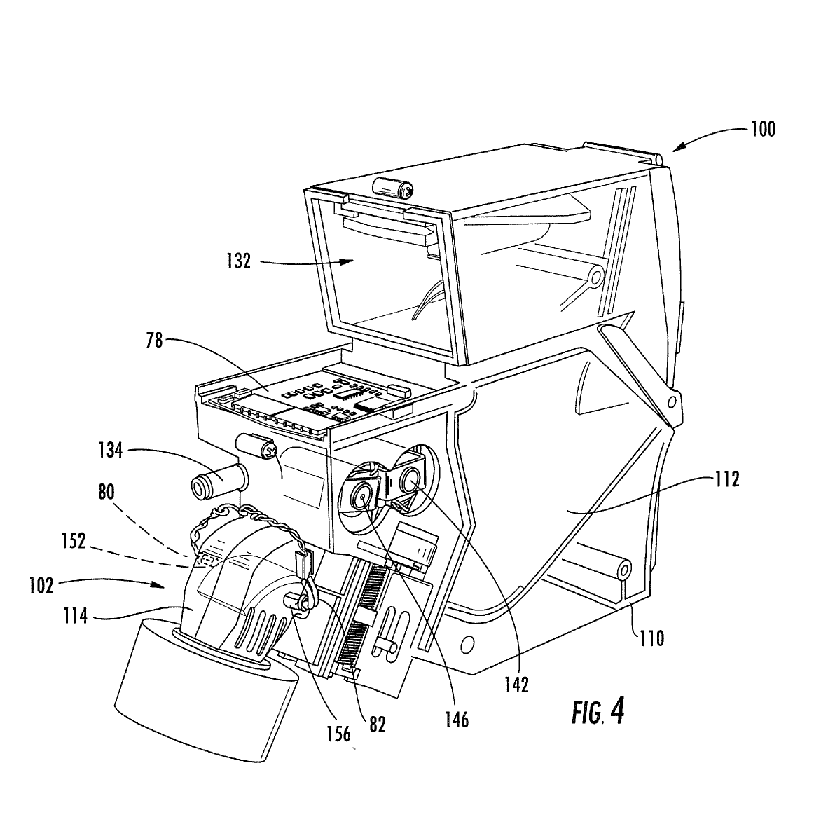

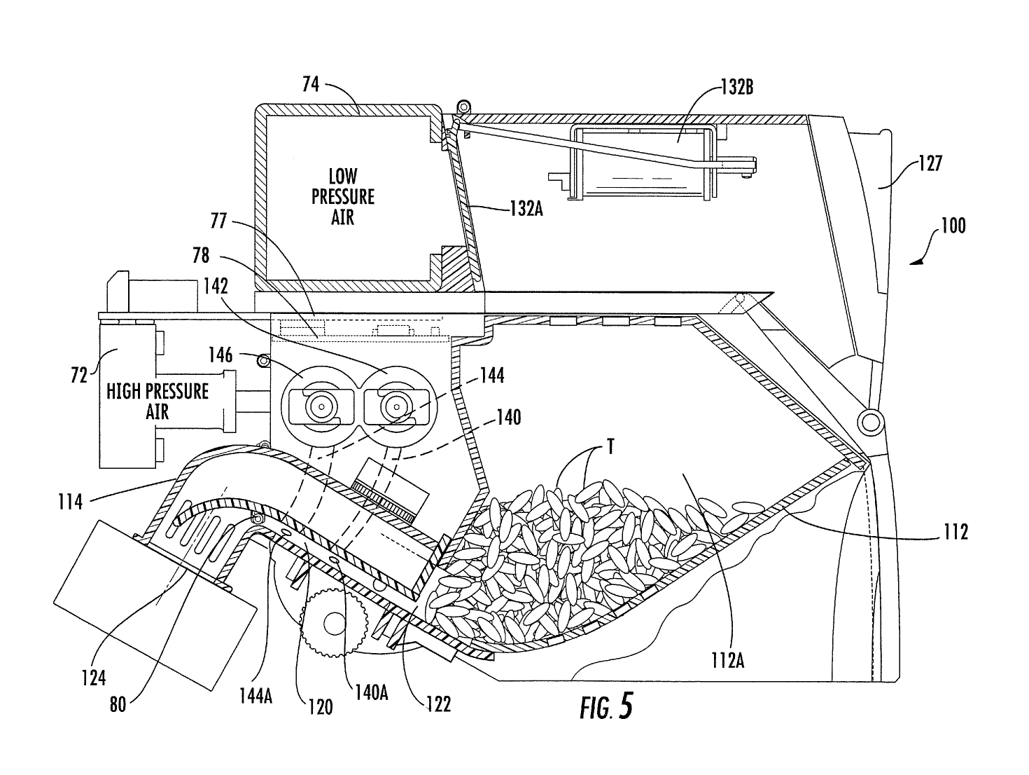

Filling of labeled containers with tablets is carried out by the tablet dispensing station 62. The tablet dispensing station 62 comprises a plurality of tablet dispensing bin assemblies or bins 100 (described in more detail below), each of which holds a bulk supply of individual tablets (typically the bins 100 will hold different tablets). Referring to FIGS. 4 and 5, the dispensing bins 100, which may be substantially identical in size and configuration, are organized in an array mounted on the rails of the frame 44. Each dispensing bin 100 has a dispensing channel 120 with an outlet 124 that faces generally in the same direction, to create an access region for the dispensing carrier 70. The identity of the tablets in each bin is known by the controller 42, which can direct the dispensing carrier 70 to transport the container to the proper bin 100. In some embodiments, the bins 100 may be labeled with a bar code, RFID tag or other indicia to allow the dispensing carrier 70 to confirm that it has arrived at the proper bin 100.

The dispensing bins 100 are configured to singulate, count, and dispense the tablets contained therein, with the operation of the bins 100 and the counting of the tablets being controlled by the controller 42. According to some embodiments, each bin 100 includes its own dedicated controller that is operative to execute a dispensing run upon receiving a command from a central controller or the like. Some embodiments may employ the controller 42 as the device which monitors the locations and contents of the bins 100; others may employ the controller 42 to monitor the locations of the bins, with the bins 100 including indicia (such as a bar code or electronic transmitter) to identify the contents to the controller 42. In still other embodiments, the bins 100 may generate and provide location and content information to the controller 42, with the result that the bins 100 may be moved to different positions on the frame 44 without the need for manual modification of the controller 42 (i.e., the bins 100 will update the controller 42 automatically).

Any of a number of dispensing units that singulate and count discrete objects may be employed if suitably modified to include the inventive aspects disclosed herein. In particular, dispensing units that rely upon targeted air flow and a singulating nozzle assembly may be used, such as the devices described in U.S. Pat. No. 6,631,826 to Pollard et al. and/or U.S. Patent Publication No. US-2006-0241807-A1, each of which is hereby incorporated herein by reference in its entirety. Bins of this variety may also include additional features, such as those described below.

After the container is desirably filled by the tablet dispensing station 62, the dispensing carrier 70 moves the filled container to the closure dispensing station 64. The closure dispensing station 64 may house a bulk supply of closures and dispense and secure them onto a filled container. The dispensing carrier 70 then moves to the closed container, grasps it, and moves it to the offloading station 66.

Turning to the bins 100 in more detail, an exemplary bin 100 is shown in more detail in FIGS. 4-14. The bin 100 includes a housing 110 having a hopper portion 112 and a nozzle 114.

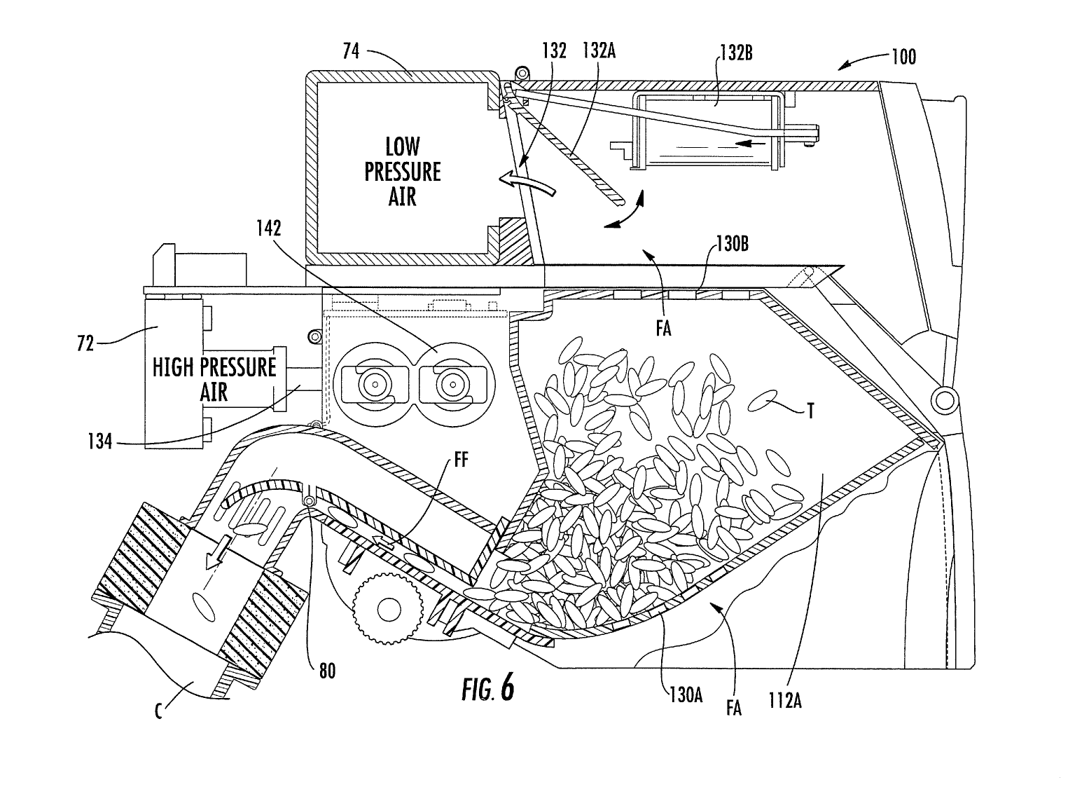

Referring to FIG. 6, the hopper portion 112 defines a hopper chamber 112A that can be filled with tablets T. A lower screen 130A is provided in the floor of the hopper portion 112 and an upper screen 130B is provided in the ceiling of the hopper portion 112. As discussed below, air can be flowed through the screens 130A, 130B and the hopper chamber 112A to agitate the tablets T contained therein.

With reference to FIG. 5, the nozzle 114 defines a dispensing channel 120 through which the tablets T can be dispensed one at a time. The dispensing channel 120 has an inlet 122 adjacent and fluidly connecting the channel 120 to the hopper chamber 112A. The dispensing channel 120 has an outlet 124 opposite the inlet 122 and through which tablets may exit the nozzle to be dispensed into the container C (FIG. 7).

The housing 110 further includes a low pressure port 132 and a high pressure nozzle 134 (FIGS. 4 and 6). A door 132A is provided to selectively open and close the port 132 by operation of an associated solenoid 132B.

With reference to FIG. 5, a forward jet passage 140 is fluidly connected to the high pressure nozzle 134 and terminates in a forward jet aperture 140A at the dispensing channel 120. A forward control valve 142 is operable to control airflow to the jet aperture 140A. A rearward jet passage 144 is also fluidly connected to the high pressure nozzle 134 and terminates in a rearward jet aperture 144A at the dispensing channel 120. A rearward control valve 146 is operable to control airflow to the jet aperture 144A.

According to some embodiments and as described in U.S. Patent Publication No. US-2006-0241807-A1, the tablet dispensing station 62 includes a low pressure manifold 74 fluidly connected to a low pressure source such as a vacuum motor (not shown), which provides low level (i.e., about 2 psi) suction to draw air through (in succession) the screen 130A, the hopper chamber 112A, the screen 130B and the port 132 to agitate tablets within the hopper chamber 112A (FIG. 6). Also, a high pressure (i.e., about 30 psi) conduit 72 fluidly connected to a high pressure source (not shown) is fluidly connected to the high pressure nozzle 134 to supply high pressure air to the jet apertures 140A, 144A. Further, a connector circuit board 77 is mounted horizontally below the manifold 74. The circuit board 77 or other electrical connector provides an electrical connection between the controller 42 and a bin-controlling circuit board 78 (or other electronic component) of the bin 100 for power and data signals from the controller 42, (such as those that control the application of suction and/or positive pressure through the conduit 72), and the counting sensors 80, 82.

A left outrigger structure 152 (FIGS. 4 and 8-14) and a right outrigger structure 156 (FIGS. 4 and 14) are mounted on and extend laterally outwardly from opposed walls 126 of the nozzle 114. A left sensor 80 (FIGS. 4-8 and 14) is mounted on the left outrigger structure 152 and faces the channel 120 through a sensor port 150. A right sensor 82 (FIGS. 4 and 14) is mounted on the right outrigger structure 156 and faces the channel 120 through a sensor port 154. The sensors 80, 82 may be sealed or secured in place by gaskets 86 (FIG. 14) or the like.

According to some embodiments, the sensors 80, 82 are counting sensors and are operably connected to associated sensor receiver/processor electronics. As further discussed below, the sensors 80, 82 are configured and positioned to detect the tablets T as they pass through the dispensing channel 120. According to some embodiments, the sensors 80, 82 are photoelectric sensors. According to some embodiments, at least one of the sensors 80, 82 includes a photoemitter and the other sensor 80, 82 includes a photodetector that receives photoemissions from the photoemitter of the first sensor 80, 82. The sensors 80, 82 have respective exposed surfaces 80A, 82A through which light or other emitted or detected radiation is emitted or received. According to some embodiments, the sensors 80, 82 share a reciprocal line of sight A-A through the ports 150, 154 and the channel 120. Suitable sensors may include infrared (IR) sensors. Other suitable types of sensors may include, for example, UV, RF, capacitive and EMF sensors.

In use, to fill the container, the dispensing carrier 70, directed by the controller 42, moves the container to the exit port of the selected dispensing bin 100. The controller 42 signals the solenoid 132B to open the door 132A. This opening of the door 132A draws low pressure air up through the hopper chamber 112A to the manifold 74, thereby agitating the tablets T contained in the hopper chamber 112A.

Once agitation has commenced, the controller 42 signals the forward valve 142 connected with the forwardly-directed jet aperture 140A to open, which generates suction that causes a forward flow FF of high pressure air to be drawn outwardly through the dispensing channel 120 (FIG. 6). Tablets T are oriented into a preferred orientation by the shape of the inlet 122 to the dispensing channel 120 and dispensed into the container through the dispensing channel 120 and the outlet 124. The counting sensors 80, 82 count the tablets T as they pass through a predetermined point in the dispensing channel 120. Once dispensing is complete (i.e., a predetermined number of tablets has been dispensed), the controller 42 activates the rearward valve 146 associated with the rearwardly-directed jet aperture 144A and deactivates the solenoid 132B, thereby closing the door 132A (FIG. 7). The high pressure air forced into the channel 120 through the rearwardly-directed jet aperture 144A generates suction that causes a rearward flow FR of high pressure air to be drawn inwardly through the dispensing channel 120 (FIG. 7) toward the hopper chamber 112A. In this manner, the airflow is reversed and any tablets T remaining in the channel 120 are returned to the hopper chamber 112A.

While, in the foregoing description, the valves 142, 146 are controlled by the controller 42, the valves 142, 146 may alternatively be controlled by a local controller unique to each bin 100. The bin 100 can be filled or replenished with tablets via access from a pivoting door 127 located at the upper rear portion of the bin 100, for example. As disclosed in U.S. Patent Publication No. US-2006-0241807-A1, the bin 100 may include components that permit the entry to the dispensing channel 120 to be adjusted in size to complement the size and configuration of the tablet to be dispensed.

As the tablets T are agitated and passed through the dispensing channel 120, significant amounts of dust and debris may be generated and introduced into the dispensing channel 120. Such dust and debris may tend to collect on the exposed surfaces 80A, 82A of the sensors 80, 82. The collected dust may block or deflect the light emitted from (in the case of a photoemitter) or received by (in the case of a photodetector) the associated sensor 80, 82, thereby degrading the sensor's performance. Ultimately, such performance degradation may cause tablets to go uncounted or may require that the bin 100 be taken offline to remove the sensor and clean the dust from the sensor. Such effects may cause significant inconvenience for the operator and/or negatively affect the reliability of the system 40.

The foregoing concerns with regard to dust and debris accumulation may be addressed by the bin 100 in accordance with embodiments of the present invention. The bin 100 is provided with a sensor clearing system 102 including the outriggers 152, 156. As noted above, the sensors 80, 82 are mounted on the outriggers 152, 156. According to some embodiments, the outrigger strictures 152, 156 are integrally formed with the side walls 126, such as by integral molding. The outrigger structures 152, 156 are constructed and configured in the same manner except that they are mirror images of one another about the lengthwise axis of the dispensing channel 120. Accordingly, the outrigger 152 will be described in further detail, it being appreciated that this description likewise applies to the outrigger 156 and its engagement with the sensor 82. According to other embodiments, the outrigger structures 152, 156 may be differently formed from one another. For example, according to some embodiments, the outrigger structures are slightly different in size to accommodate other system variances.

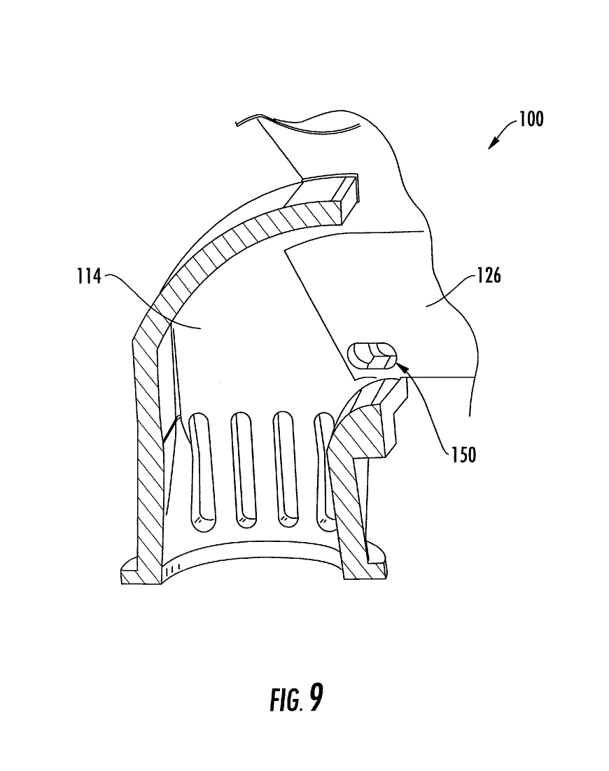

As best seen in FIGS. 10-14, the outrigger 152 includes a body 160, a central passage 162, a sensor mount slot or opening 164, a front port 166 and a rear port 168. The central passage 162 and the ports 166, 168 fluidly communicate with the sensor port 150.

In use, the ports 162, 166 and 168 provide flows E of air (or other suitable gas) that agitate dust adjacent the sensor surface 80A to thereby remove dust from the sensor surface 80A and/or prevent dust from depositing on the sensor surface 80A. The airflows E travel along paths different from the paths of the airflows FF, FR that force the tablets T through the dispensing channel 120. More particularly, the suction generated by providing a high pressure airflow through the forward jet aperture 140A or the rearward jet aperture 144A creates low pressure regions at the ports 166, 168 that draw air through the ports 166, 168, which travels adjacent the sensor surface 80A, through the central passage 162, through the port 150 and into the dispensing channel 120 where it joins the tablet conveying airflow FF or FR. According to some embodiments, the airflows E are supplied from ambient air such as the ambient air proximate the ports 166, 168. As such, the airflows E may be relatively free of dust.

According to some embodiments, at least some of the airflows E are directed onto the surface 80A. According to some embodiments, at least some of the airflows E are directed adjacent but not onto the surface 80A so that they generate turbulence that agitates dust on the surface 80A. According to some embodiments, the path(s) of at least some of the airflows E extend, in part, transversely to the lengthwise axis of the central passage 162 (i.e., the axis A-A)(e.g., generally along the axis B-B of FIG. 14).

According to some embodiments, the dimensions of the ports 150, 154 are selected such that the tablets intended to be dispensed cannot exit the nozzle 114 through the ports 150, 154. According to some embodiments, these dimensions are selected to reduce, minimize or prevent such tablets from striking an edge of the port 150, 154 in a manner that would significantly affect their travel through the passage between the inlet 122 and the outlet 124. Various of the other dimensions may be constrained or determined by the size and shape of the sensors 80, 82 and/or the desired airflow characteristics.

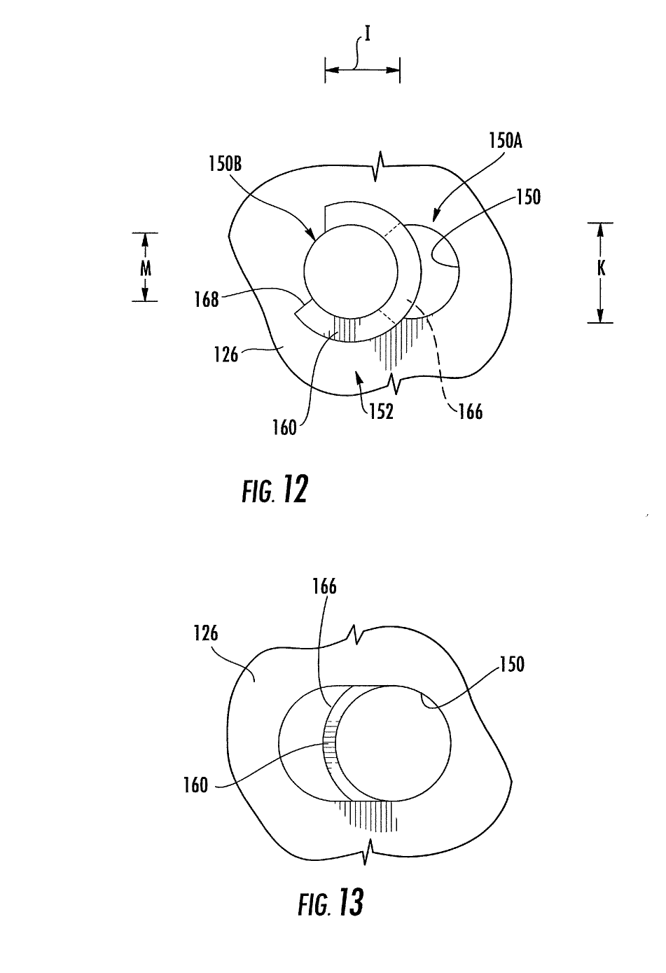

According to some embodiments, the sensor 80 and the outrigger 152 are relatively arranged and configured such that the exposed surface 80A is positioned a distance H (FIG. 14) of about 0.18 inch from the dispensing channel 120. According to some embodiments, the central passage 162 has a width I (FIG. 12) of about 0.134 inch. According to some embodiments, the central passage 162 is generally circular in cross-section. According to some embodiments, the central passage 162 has a volume (when the sensor 80 is installed) of about 0.003 in³.

According to some embodiments, the front port 166 has a laterally extending length J (FIG. 14) of about 0.118 inch. According to some embodiments, the front port 166 has a width K (FIG. 12) of about 0.134 inch. According to some embodiments, the front port 166 has an area of about 0.0158 in².

According to some embodiments, the rear port 168 has a laterally extending length L (FIG. 14) of about 0.236 inch. According to some embodiments, the rear port 168 has a width M (FIG. 12) of about 0.067 inch. According to some embodiments, the rear port 168 has an area of about 0.016 in².

According to some embodiments, the port 150 includes a portion 150A located forward of the outrigger 152 and a portion 150B coextensive with the central passage. According to some embodiments, the port 150 is substantially oval or circular. According to some embodiments, the port 150 has an area of between about 0.014 and 0.026 in².

According to some embodiments, the mass flow rate of the airflow E through the central passage 162 is at least an order of magnitude smaller than the mass flow rate of the airflow FF through the dispensing channel 120 when the tablets T are being dispensed.

The sensor clearing system 102 may serve to actively remove (i.e., dislodge) dust from and prevent dust from depositing on the exposed sensor surfaces 80A, 82A as the tablets T are dispensed and returned to the hopper chamber 112A through the dispensing passage 120. One or both of the ports 166, 168 may also serve as access ports for cleaning the exposed sensor surfaces 80A, 82A using an external cleaning mechanism. For example, an operator may insert a wiping brush, pad or the like through the ports 166, 168 and/or may direct a high velocity air flow (e.g., canned, compressed air) through the ports 166, 168.

While the sensor clearing system 102 has been described hereinabove with regard to the bin 100 and the dispensing system 40, sensor clearing systems according to embodiments of the present invention may be used with bins and/or systems of other types and configurations. Sensor clearing systems according to embodiments of the present invention may include outriggers differently configured than the outriggers 152, 156.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. An apparatus for dispensing solid pharmaceutical articles, the apparatus comprising:
a) a housing defining a dispensing passage;
b) a flow generator operable to generate a first flow of gas to force the articles along a first path through the dispensing passage;
c) a sensor positioned to detect articles passing through the dispensing passage; and
d) a port defined in the housing adjacent the sensor and configured to direct a second flow of gas along a second path to agitate dust adjacent the sensor and thereby remove dust from the sensor and/or prevent dust from depositing on the sensor.

2. The apparatus of claim 1 wherein the second flow of gas is supplied from ambient air.

3. The apparatus of claim 2 wherein the first flow of gas creates a low-pressure region at the port to thereby generate the second flow of gas through the port.

4. The apparatus of claim 1 wherein the port is configured to direct the second flow of gas onto the sensor.

5. The apparatus of claim 1 wherein the sensor is mounted on the housing.

6. The apparatus of claim 5 wherein the housing includes an outrigger structure that extends laterally outwardly from the dispensing passage, the sensor is mounted on the outrigger stricture, and the port is defined in the outrigger structure.

7. The apparatus of claim 6 wherein the housing includes a wall defining a portion of the dispensing passage and the outrigger structure is integrally formed with the wall.

8. The apparatus of claim 1 including a second port defined in the housing adjacent the sensor and configured to direct a third flow of gas along a third path to agitate dust adjacent the sensor and thereby remove dust from the sensor and/or prevent dust from depositing on the sensor.

9. The apparatus of claim 1 wherein the flow generator includes:
a jet aperture in fluid communication with the dispensing passage; and
a positive pressure source fluidly connected to the jet aperture to provide a gas jet to force the articles through the dispensing passage.

10. The apparatus of claim 1 wherein the flow generator includes:
a positive pressure source to provide the first flow of gas; and
a controller to selectively control the positive pressure source.

11. The apparatus of claim 1 including:
a second sensor mounted on the housing to detect articles passing through the dispensing passage; and
a second port defined in the housing adjacent the second sensor and configured to direct a third flow of gas along a third path to agitate dust adjacent the second sensor and thereby remove dust from the second sensor and/or prevent dust from depositing on the second sensor.

12. The apparatus of claim 11 wherein the first and second sensors oppose one another across the dispensing passage.

13. The apparatus of claim 11 including:
a third port defined in the housing adjacent the first sensor and configured to direct a fourth flow of gas along a fourth path to agitate dust adjacent the first sensor and thereby remove dust from the first sensor and/or prevent dust from depositing on the first sensor; and
a fourth port defined in the housing adjacent the second sensor and configured to direct a fifth flow of gas along a fifth path to agitate dust adjacent the second sensor and thereby remove dust from the second sensor and/or prevent dust from depositing on the second sensor.

14. The apparatus of claim 1 wherein the sensor is a counter sensor.

15. The apparatus of claim 1 wherein the housing includes a hopper in fluid communication with the dispensing passage and configured to hold the articles.

16. The apparatus of claim 1 wherein:
the housing defines a dispensing inlet and a dispensing outlet each in fluid communication with the dispensing passage; and
the sensor is positioned between the dispensing outlet and the dispensing inlet.

17. A method for dispensing solid pharmaceutical articles using an apparatus including a housing defining a dispensing passage, a flow generator, and a sensor positioned to detect articles passing through the dispensing passage, the method comprising:
generating a first flow of gas using the flow generator to force the articles along a first path through the dispensing passage;
detecting articles passing through the dispensing passage using the sensor; and
directing a second flow of gas along a second path through a port defined in the housing adjacent the sensor to agitate dust adjacent the sensor and thereby remove dust from the sensor and/or prevent dust from depositing on the sensor.

18. The method of claim 17 including supplying the second flow of gas from ambient air.

19. The method of claim 18 wherein the first flow of gas creates a low-pressure region at the port to thereby generate the second flow of gas through the port.

20. The method of claim 17 including directing the second flow of gas onto the sensor.

21. The method of claim 17 wherein the housing includes an outrigger structure that extends laterally outwardly from the dispensing passage, the sensor is mounted on the outrigger structure, and the port is defined in the outrigger structure.

22. The method of claim 21 wherein the housing includes a wall defining a portion of the dispensing passage and the outrigger structure is integrally formed with the wall.

23. The method of claim 17 including directing a third flow of gas along a third path through a second port defined in the housing adjacent the sensor to agitate dust adjacent the sensor and thereby remove dust from the sensor and/or prevent dust from depositing on the sensor.

24. The method of claim 17 including forcing the articles through the dispensing passage using a gas jet.

25. The method of claim 17 including positively controlling a positive pressure source to provide the first flow of gas.

26. The method of claim 17 including:
detecting articles passing through the dispensing passage using a second sensor;
directing a third flow of gas along a third path through a second port defined in the housing adjacent the second sensor to agitate dust adjacent the second sensor and thereby remove dust from the second sensor and/or prevent dust from depositing on the second sensor.

27. The method of claim 26 wherein the first and second sensors oppose one another across the dispensing passage.

28. The method of claim 26 including:
directing a fourth flow of gas along a fourth path through a third port defined in the housing adjacent the first sensor to agitate dust adjacent the first sensor and thereby remove dust from the first sensor and/or prevent dust from depositing on the first sensor; and
directing a fifth flow of gas along a fifth path through a fourth port defined in the housing adjacent the second sensor to agitate dust adjacent the second sensor and thereby remove dust from the second sensor and/or prevent dust from depositing on the second sensor.

29. The method of claim 17 including counting the articles passing through the dispensing passage using the sensor.

30. The method of claim 17 including dispensing the articles from a hopper of the housing into the dispensing passage.
